(19) United States
(12) Patent Application Publication
(10) Pub. No.: US 2010/0299362 A1
(43) Pub. Date: Nov. 25, 2010

(54) METHOD FOR CONTROLLING ACCESS TO DATA CONTAINERS IN A COMPUTER SYSTEM

(76) Inventor: Roger Frederick Osmond, Littleton, MA (US)

Correspondence Address: Roger Frederick Osmond, 273 Harwood Avenue, Littleton, MA, 01460, US

(21) Appl. No.: 12/785,752

(22) Filed: May 24, 2010

Related U.S. Application Data
(60) Provisional application No. 61/180,879, filed on May 24, 2009.

(51) Int. Cl. G06F 17/30

(52) U.S. Cl. 707/781; 707/E17.001

(57) ABSTRACT

A method for controlling access to stored objects in a computer system is provided that is both powerful and flexible, and minimizes complexity to the user. The method may apply to logical containers of objects and supports arbitrary configurations of logical containers, including nests and hierarchies. The method extends beyond the simple notion of permission, to include not only operation-oriented rights, but more complex and possibly dynamic access conditions, criteria and rules. The method provides for association of actions to be triggered and performed, optionally, in relation to access or attempted access to stored objects.

This invention claims priority to U.S. Provisional Patent Application No. 61/180,879 entitled “Method for controlling access to data containers in a computer system” filed May 24, 2009.

### BACKGROUND OF THE INVENTION

The present invention relates generally to computer software and computer based data storage. Aspects of this invention also relate particularly to controlling access to data stored in container-like constructs in a computer system.

Access to data in computer systems typically comprises 3 major categories: Authentication, Authorization and Access Control. Authorization verifies the identity of a user, and often involves user name/password combinations. Authorization also deals with identity, typically determining that a user has certain rights, belongs to a group, or has paid the bill. Access control can also deal with identity, but can include other factors like time of day. In practice, these categories overlap, in some cases combining into a single process. Especially common is a merge of authorization and access control. In the context of this invention, the term “access control” is meant to include both authorization and access control.

There are a number of different access control methods for data in computer systems. The focus of this invention is on data stored as objects in container-like constructs. A possible analog to this might be files in a file system, though in accordance with the present invention, objects are not limited to files or any other particular mechanism or structure, and container-like constructs are not limited to directories or any particular structure or mechanism.

In a typical file system, objects (e.g. file and directories) have per-object ownership and permissions. In many systems, there is support for groups of users. Older UNIX® systems limited the number of groups to which a single user could belong to 7. Later versions increased that limit, and current Linux® versions allow 32 bits worth (˜4B) per user.

Regardless of the number of groups to which a user can belong, the per-file ownership and permission model imposes certain limitations and is complex and difficult to manage at any but the smallest scales.

In recent years, UNIX-like file systems have added access control lists (ACLs) to enhance the traditional user-group-other permissions mechanism. The addition of ACL support does not materially affect the model beyond a slight improvement in manageability. Other operating systems and file systems have similar mechanisms.

It would be advantageous for a computer system to provide a more flexible and less complex means of controlling access to stored objects. Access control should also extend beyond the simple notion of permission to include not only the basic operation-oriented rights, but more complex and possibly dynamic access conditions, as well as the ability to associate triggered actions with an access.

### BRIEF SUMMARY OF THE INVENTION

The present invention comprises methods that provide a powerful and flexible access control mechanism, with minimal complexity. The methods include per-container access policies. This contrasts with the per-object ownership and permission methods typical in file systems. The methods also include provisions for specialized, complex or dynamic access conditions, and the ability to associate with and trigger actions upon access.

### BRIEF DESCRIPTION OF THE SEVERAL VIEWS OF THE DRAWING

The present invention may be better understood by referring to the following description taken in conjunction with the accompanying drawings in which:

FIG. 1 depicts a data container and contained objects,

FIG. 2 depicts an access policy comprising a number of access conditions, each a tuple of access mode, access group, access rule and access action,

FIG. 3 depicts an access control map,

FIG. 4 depicts an access control map with access groups defined,

FIG. 5 depicts a flow of logic for a method of controlling data access,

FIG. 6 depicts a flow of logic for a method of applying rules,

FIG. 7 depicts a flow of logic for a method of performing actions, and

FIG. 8 depicts the tri-state behavior of rule-based conditions.

### DETAILED DESCRIPTION OF THE INVENTION

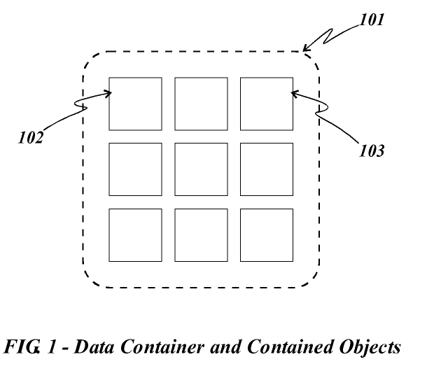

In accordance with the present invention, an access control method offers flexibility with minimal complexity. Where traditional methods apply access controls to individual data objects (files), the method of the present invention applies access controls explicitly to containers of objects, such that access to the objects within the container is controlled implicitly by way of the container. FIG. 1 depicts a data container comprising a number of objects where Item 101 is the data container and the other items, including Items 102 and 103 are objects held within that container.

In the preferred embodiment, containers could be nested such that a container can contain other containers as well as objects other than containers (e.g. data objects). Each container would have a single owner such that all objects held within a container would have a single owner. The owner of the container would have the right to grant access, in various modes, to other users. Because all objects held within a container belong to the single owner of that container, the need for per-object ownership is obviated.

According to the present invention, access to containers is controlled by a per-container access policy. Each container has an access policy. An access policy is a collection of access conditions. The preferred embodiment includes 6 access conditions for each container.

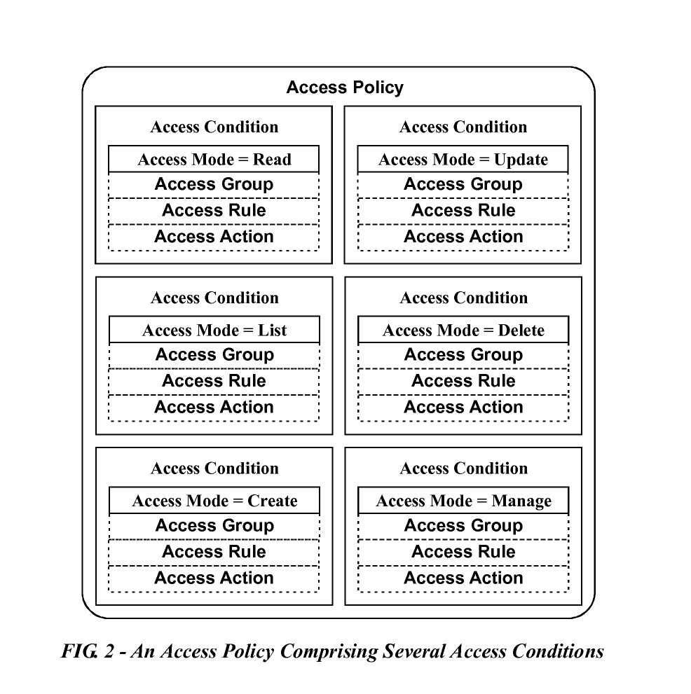

FIG. 2 depicts an access policy comprising a number of access conditions.

Each access condition is a tuple of an access mode, an access group, an access rule and an access action. In the preferred embodiment, access modes include: read, list, create, update, delete and manage. Additional access modes are also possible. Each access condition is defined separately, although macro-like commands could combine setting multiple, perhaps all, access conditions in a single operation if desired. Access modes are characterized as follows.
Read mode for a container permits a user to see a data object held by that container, and to see the data within the data object. Read permission does not imply list permission.
List mode for a container permits a user to see (i.e. list) the objects held by that container. List permission does not imply read permission, and so it is possible to have permission to see an object without having permission to read its contents and vice versa.
Create mode for a container permits a user to add new objects to the container. Create permission does not imply update permission.
Update mode for a container permits a user to replace an existing object held in that container with another object, or to modify an existing object's contents.
Delete mode for a container permits a user to delete from that container an object held in that container.
Manage mode for a container permits a user to manage the other access modes.

An access group is a collection of user identifiers and/or access group identifiers to whom access rights can be granted. The members of an access group associated with an access mode by means of an access condition are granted the access rights associated with the associated access mode.

In the preferred embodiment, there are 2 predefined and immutable access groups, called Public and Private. The Public access group includes by definition every possible entity. The Private access group includes only a container's owner. A container's owner is by definition at least an implicit member of each of the access groups defined by that owner for that owner's containers.

Each access condition in a container's access policy has at most one access group. By association then, each access mode in a container's access policy has at most one access group. As there can be any number of groups, and groups can include other groups, any desired combination of user and group identifiers can be devised as a group and so a maximum of one group per condition is not limiting. It would be possible for example, using this method, to create a group per container, with that per-container group comprising any number of individual and group entities.

When an access condition in a container's access policy does not have an access group assigned (i.e. the access groups for a container is undefined), the access condition defers to the next enclosing container's access condition. In each outermost (i.e. top level) container, each access condition has an immutable access group of Private.

In the preferred embodiment, access groups are assigned per container, but are defined by an owner for use by any of that owner's containers (i.e. groups can be used for more than one container). Each defined access group is assigned an access group number (a decimal integer). The predefined groups Public and Private might have access group numbers 1 and −1 respectively, leaving group number of 0 to denote “undefined”.

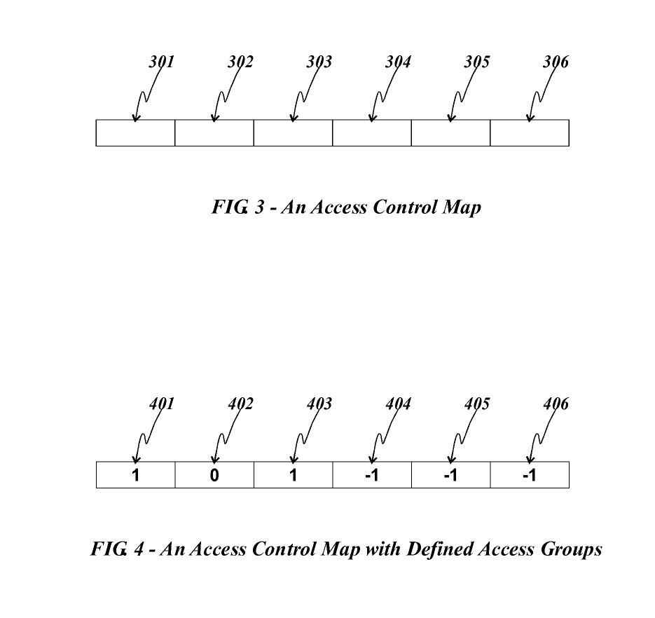

A virtual container's access policy may be encoded as a map, as depicted in FIG. 3. Items 301 through 306 represent the access conditions associated with each access mode. The map could be as simple as a sequence of group numbers, where the position of the group number denotes its access condition. For example, the first group number in the sequence might denote the Read access condition.

FIG. 4 depicts a simple map representing an access policy. Item 401 represents the Read access condition. The access group in that position is 1, denoting Public read access. Item 403, representing Create access also has an access group of 1, denoting Public Create access. Items 404, 405 and 406, representing Update, Delete and Manage access, respectively, have access groups of −1, denoting Private Update, Delete and Manage access (i.e. only the owner has Update, Delete and Manage rights for that container).

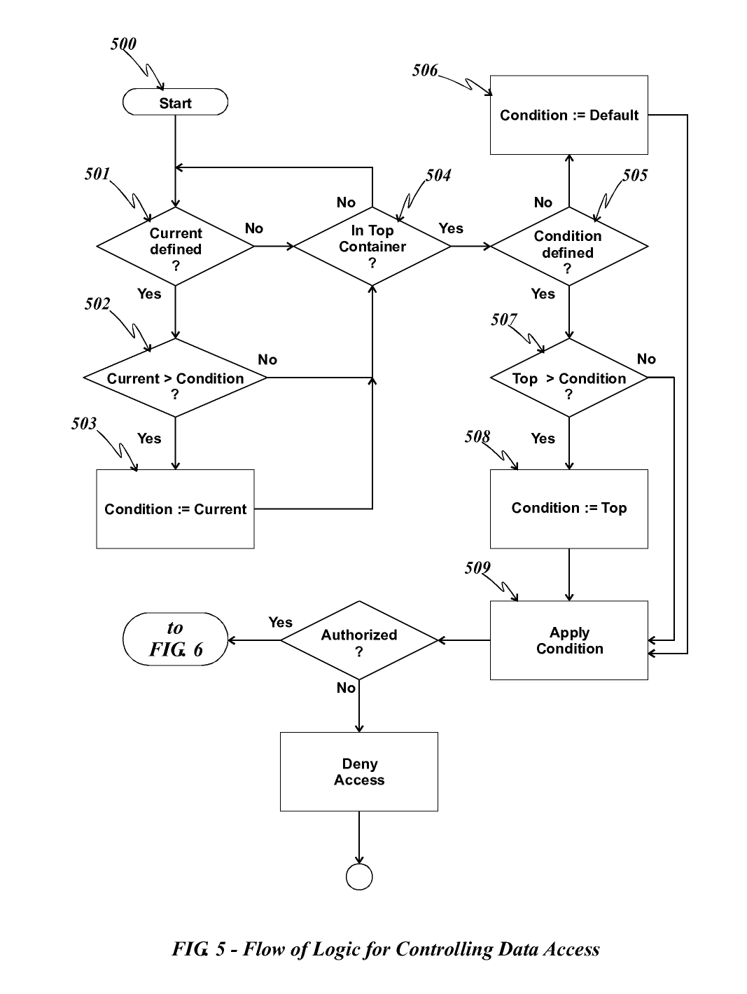

Item 402 in FIG. 4, representing List access has an access group of 0, meaning that no access group has been assigned for that access condition (i.e. the access group is undefined). In this case, the access condition for this container defers to the access condition of the immediately enclosing container. If the first container is the outermost container, then the default access condition applies. The default access group for each access condition in the outermost container is Private. FIG. 5 depicts the logic flow for this condition.

Access control traditionally involves simple access rights and authorization, but in the present invention includes more. Access control may include any number of other factors for consideration, such as time-of-day, account standing, number of accesses per unit time, number of simultaneous accesses and so forth.

The present invention provides such support by permitting the association of additional rules and actions to container access attempts. The method is fully extensible.

In accordance with the present invention, the method, upon an access attempt by an authenticated user, and upon analyzing the access attempt with respect to access mode, and having determined that the access condition as defined has been satisfied, can apply the rules and actions associated with that container. Each access condition in a container's access policy has exactly one access rule and one access action.

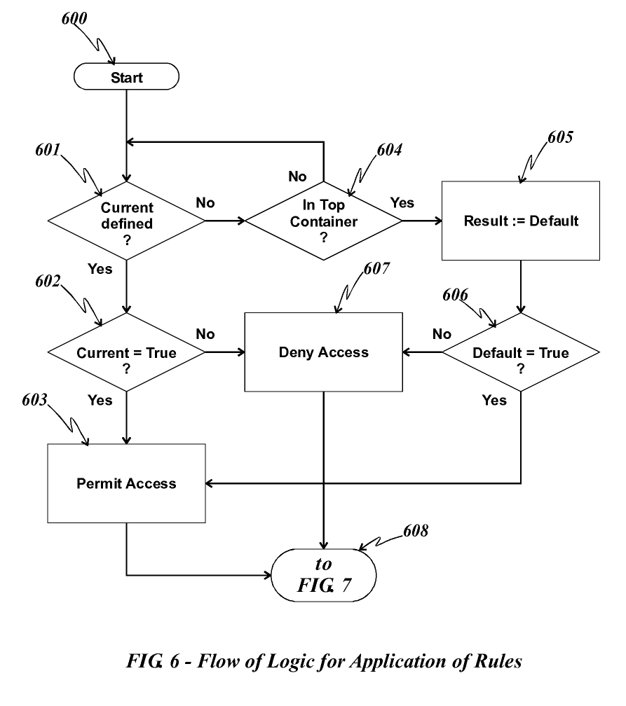

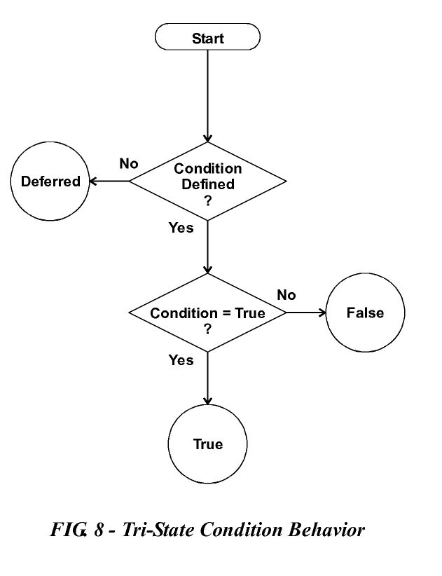

FIG. 6 extends the flow of logic in FIG. 5 to include rule evaluation. Rules comprise additional factors for consideration with respect to access. A rule can define a condition that must be satisfied or, absent a defined condition, is deferred. Evaluating a rule for which there is a defined condition is equivalent to evaluating the condition defined for that rule. The result of evaluating a defined condition is either True or False. If the condition is satisfied, the result is True, else it is False. If, however, a rule does not have a defined condition, i.e. it is deferred, then there is no condition to satisfy or not satisfy, and as such the rule evaluates to Deferred. FIG. 8 depicts the tri-state behavior of rule-based conditions.

A rule evaluating to Deferred causes the method to evaluate the corresponding rule (i.e. the rule corresponding to the equivalent access condition) in the immediately enclosing container. This process is recursive such that, in the case where no inner containers have rules with defined conditions, the method evaluates eventually the rule defined for the outermost container

In the preferred embodiment, the outermost container has a default rule that evaluates always to True, for each access condition. Inner containers (i.e. not an outermost container) have by default rules with no defined conditions (i.e. the rule associated with each access condition has no defined condition and is therefore deferred), deferring to the outermost container. A rule can, but need not include reference to the default rule. For example, a container might have a rule of the form:

IF default_rule = True THEN

Result := A

ELSE

Result := B

END

where A and B represent Boolean values or expressions, including additional rule expressions.

Conditions defined by rules can include single value conditionals, Boolean constants, complex conditionals, or calls to external processes or processors, and any combination thereof. A rule can effectively define a condition to be anything that evaluates to a Boolean value.

In the present invention, evaluation of a rule (and therefore of its defined condition, if any) is a query in that it represents a (Boolean) value, and does not change the state of the container with which it is associated. The method itself might however, upon completion of a rule query, change the state of the associated container for relevant accesses. In contrast, actions are imperatives and can change the state of the container, or of other objects, but do not represent a value.

Because the method evaluates rules after authentication (i.e. matching access mode with access group membership), it is possible for a rule to prohibit an access that according to the access mode and access group values would otherwise have been granted. This is important to provide the added flexibility of the method. This behavior is likely to apply most commonly as additional restrictions to non-owner entities. For example, an owner could grant Read access rights to Public for a container, but add a rule that requires a specialized operation such as entering a password. This behavior can also apply to the owner of a container. For example, a container could have access groups of Private for Update and Delete. In the absence of additional rule-based restrictions, this would permit the owner of that container, and no one else, to update objects in the container, and to delete objects from the container (because the owner belongs to all groups, and the default outermost access group number is 1). With a rule that prevents even the owner from accessing the container for Update, Delete and Manage, the container effectively becomes write-only. A write-only configuration can be especially valuable for data integrity assurance and for regulatory compliance. The method supports any number of possible configurations and applications.

Actions comprise additional steps to take upon successful authentication and authorization (i.e. analysis of the access policy). In the preferred embodiment, ingest actions are performed immediately upon successful authentication, authorization, and evaluation of any rule-based conditions. The action itself can include delays and deferrals, but the method triggers the action immediately. Actions are imperatives.

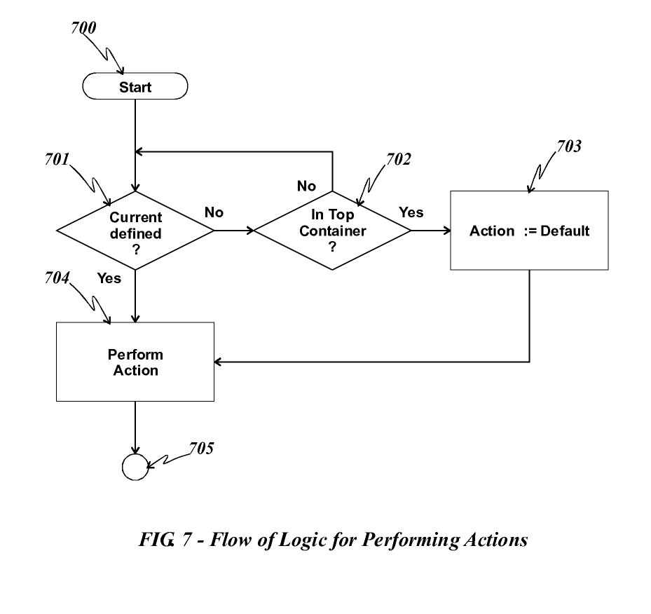

FIG. 7 extends the flow of logic in FIG. 5 and FIG. 6 to include actions.

Actions can include single operations or can combine multiple operations into an action sequence (a single action from the point of view of a container). A defined action can be applied to multiple containers, to multiple access conditions in a container, or both.

A container's rules are evaluated before actions are performed. A rule can be defined such that it influences one or more actions, including to the extent that the action is or is not performed. In the preferred embodiment, parameters passed to actions at execution time include the results of authorization and rule evaluation.

There are many possible uses of the present invention, and as such the scope of the present invention is not limited to authentication or even to traditional access control. Uses may include but are not limited to virus protection, indexing and classification, data transformation (including compression, encryption, de-duplication and common file elimination), digital rights enforcement, usage accounting and billing, video transcoding and analytics.

While it is possible to devise ad hoc solutions that provide one or more similar functions, doing so often leads to much greater system and operational complexity. The integrated method of the present invention offer greater flexibility, reduces complexity and improves manageability, while offering greater overall control and finer granularity of control.

UNIX® is a registered trademark of The Open Group.
Linux® is the registered trademark of Linus Torvalds in the U.S. and other countries.

What is claimed is:

1. A method for controlling access to objects stored in a computer system;
wherein ownership and access rights may be attributes of object containers and,
wherein ownership and access rights of contained objects are implied by presence of said objects in an object container and,
wherein object containers may be in the form of logical entities, including but not limited to file systems, folders and directories, and data structures in various forms including but not limited to lists, chains, trees, arrays, queues and tables.

2. The method of claim 1 wherein each object container has an associated access policy comprising a plurality of access conditions and,
wherein access conditions may comprise an access mode, and access group, and a plurality of access rules and access actions.

3. The method of claim 1 wherein access policies, as applied to logical containers, may be deferred from one container to another, such as from a subordinate container to a superior container in a configuration in which containers may appear to be nested or layered.

4. The method of claim 1 wherein an access policy may include an access condition that asserts control over modification of said access policy.

5. The method of claim 1 wherein access rights permitting listing of objects stored in an object container and permitting reading the contents of an object within an object container may be defined and asserted separately.

6. The method of claim 1 wherein access rights permitting creation of an object and permitting updates to an existing object may be defined and asserted separately.

7. The method of claim 1 wherein an object container's access policy may be encoded in a compact serialized form such that the access conditions and their associated elements are encoded into that form.

8. The method of claim 1 wherein an access policy may be defined or undefined, being distinct but reasonable states, such that an undefined state may result in deferring access control decisions to another entity, including but not limited to an enclosing object container.

9. The method of claim 1 wherein access may apply to operations, including but not limited to creation of objects and object containers, addition of objects to an object container, reading the content and attributes of objects, updating the content and attributes of objects and object containers, listing the contents of object containers, deleting objects from object containers and deleting object containers.

10. The method of claim 1 wherein access by an entity that prior to effecting access control had not been authenticated or had been authenticated as anonymous, (hereinafter “anonymous access”) may be permitted.

11. The method of claim 1 wherein anonymous access may be permitted, per access policy, with the application of additional credentials, rules or actions, such as, but not limited to password, biometrics or communication with a process or entity external to the core access control logic.

12. The method of claim 1 wherein access policies may be complex conditions, in addition to operations conditions, including but not limited to date and time of access, locality, access density, account standing, bandwidth or other resource utilization levels, climate and all manner of external conditions.

13. The method of claim 1 wherein actions may be associated with access and:
wherein said actions may execute:
upon satisfaction of access criteria or rules, or
upon failure to satisfy access criteria or rules, or
unconditionally, before after or during access.

14. The method of claim 1 wherein an access policy may comprise access conditions and their respective elements, that in combination may result in a write-only or WORM (write-once-read-many) behavior.

15. The method of claim 15 wherein subsequent operations or other accesses may be controlled in accordance with rules, criteria or policies such as digital signatures, expiration date and time, and possibly other mechanisms to provide assurance of the integrity and authenticity of stored objects.
